(19) United States
(12) Patent Application Publication
(10) Pub. No.: US 2016/0067825 A1
(43) Pub. Date: Mar. 10, 2016

(54) LASER CLADDING MECHANICAL FACE SEALS

(71) Applicant: Caterpillar Inc., Peoria, IL (US)

(72) Inventors: DANIEL VERTENTEN, AURORA, IL (US); DANEIL SORDELET, PEORIA, IL (US); CONNOR HAAS, PEORIA, IL (US); DANIEL CAVANAUGH, CHILLICOTHE, IL (US); THIERRY MARCHIONE, HERBER CITY, UT (US)

(73) Assignee: CATERPILLAR INC., Peoria, IL (US)

(21) Appl. No.: 14/482,475

(22) Filed: Sep. 10, 2014

(51) Int. Cl. B23K 26/34; C22C 19/05; C22C 19/07; C22C 19/00; C22C 38/46; C22C 38/44; C22C 38/42; C22C 38/04; C22C 38/02; C22C 38/00; C22C 37/04; C22C 37/00; C22C 38/18; B22D 23/00; B23K 26/32

(52) U.S. Cl. CPC B23K 26/34; B23K 26/3233; B23K 26/3213; B23K 26/3206; C22C 19/05; C22C 19/07; C22C 19/007; C22C 38/46; C22C 38/44; C22C 38/42; C22C 38/04; C22C 38/02; C22C 38/002; C22C 37/04; C22C 37/00; C22C 38/18; B22D 23/00

(57) ABSTRACT

A method of producing a mechanical face seal, the method including a step of obtaining a cast or wrought substrate part having an inner diameter, outer diameter, and a planar surface. The method may include an exposing step to expose the planar surface to a laser. The method may further include a supply step to supply a coating material to a location at or near the laser on the planar surface in order for the coating material to form a metallurgical bond with the substrate part.

### TECHNICAL FIELD

The disclosure relates generally to the field of mechanical components formed by a laser cladding process and, more particularly, to a mechanical seal formed by a laser cladding process.

### BACKGROUND

In equipment and machinery that have rotatable shafts, seals are often utilized to retain lubricant while at the same time excluding foreign matter from bearing surfaces of the rotatable shafts. In particular, metal or mechanical face seals are used in heavy duty rotating applications, such as axles, gearboxes, tracked vehicles, conveyer systems, etc., where components are exposed to hostile, abrasive, and corrosive environments where shaft seals may quickly wear out. The mechanical face seals generally include two identical metal seal rings that are mounted face-to-face with one another in two separate housings or retainers. One of the two metal rings typically remains static within its respective retainer while the other of the two metal rings typically rotates with its counter face.

Due to the operational requirements and the wide range of environmental conditions in which these components operate in, the metal contact surfaces of the mechanical face seals may be subject to accelerated wear and tear due to frictional contact, stresses, and temperature extremes, among other things. As a result, the mechanical face seals may be made from more durable and exotic materials. However, such materials are expensive and are difficult to form.

U.S. Patent Application Publication No. 2011/0285091 (the '091 Publication), entitled “Method for Applying Wear Resistant Coating to Mechanical Face Seal,” purports to address the problem of reducing cost while maintaining desired corrosion and wear resistant. However, coating processes in related art have suffered from significant failure of adhesion. Accordingly, there is a need for an improved process for forming mechanical components such as face seals.

### SUMMARY

In one aspect, the present disclosure describes a method of producing a tightly dimensionally controlled mechanical face seal. The method may include forming a cast or wrought substrate part. The substrate part may have an inner diameter, an outer diameter, and a planar surface extending between the inner diameter and the outer diameter. The method may include supplying a coating material to a top layer of the planar surface. The method may include exposing a laser to at least the planar surface, and the exposing may include tracing the top layer of the planar surface to melt a top surface of the substrate part and the coating material together to form a metallurgical bond.

In another aspect, the present disclosure describes a method of producing a tightly dimensionally controlled mechanical face seal, including forming a cast or wrought substrate part. The substrate part may have an inner diameter, an outer diameter, and a planar surface extending between the inner diameter and the outer diameter. The method may include exposing a laser to at least one portion of the planar surface to preheat the substrate part. The method may include supplying a coating material to the planar surface that has been preheated. The method may further include exposing the laser to at least one portion of the planar surface that has been preheated to melt a top surface of the substrate part and the coating material together to form a metallurgical bond.

In yet another aspect, the present disclosure describes a method of producing a tightly dimensionally controlled mechanical face seal, including forming a cast or wrought substrate part made of SAE 52100 alloy steel, SAE 1020 alloy steel, SAE 1040 alloy steel, ductile iron, or grey cast iron. The substrate part may have an inner diameter, an outer diameter, and a planar surface extending between the inner diameter and the outer diameter. The method may include exposing a laser to at least one portion of the planar surface to preheat the substrate part. The method may include supplying a coating material comprising a Fe-based alloy, a Ni-based alloy, or a Co-based alloy to the planar surface that has been preheated and further exposing the laser to the at least one portion of the planar surface that has been preheated to melt a top surface of the substrate part and the coating material together to form a metallurgical bond. The supplying and further exposing may form an intermediate layer by melting the coating material and a material of the substrate part together, and may form a cladding layer of the coating material above the intermediate layer. The Fe-based alloy may consist of 0.78% to 1.05% carbon, 0.15% to 0.40% manganese, 0.20% to 0.45% silicon, 2.0% to 4.5% chromium, 4.5% to 5.5% molybdenum, 5.5% to 6.75% tungsten, 1.75% to 2.20% vanadium, up to 0.3% nickel, up to 0.25% copper, up to 0.03% phosphorus, up to 0.03% sulfur, and a balance of iron. The Ni-based alloy may consist of 16-17% chromium, 3.3% boron, 3.8% silicon, 0.8% to 1.0% carbon, and a balance of nickel. The Co-based alloy may consist of 26.5% to 33% chromium, 0.8% to 2.7% carbon, 3.5% to 20% tungsten, 0.8% to 1.2% silicon, up to 3% iron, up to 1.5% molybdenum, up to 1% manganese, and a balance of cobalt.

### BRIEF DESCRIPTION OF THE DRAWINGS

The disclosure will become more fully understood from the following detailed description, taken in conjunction with the accompanying Figures, wherein like reference numerals refer to like elements.

FIG. 1 is a perspective view of an exemplary machine in which the disclosed mechanical face seals may be used, the machine is depicted next to a full-sized sports utility vehicle.

FIG. 2 is a cutaway perspective view of a gearbox used in the exemplary machine of FIG. 1.

FIG. 3 is a cross-sectional view of a first seal assembly of the gearbox of FIG. 2.

FIG. 4 is a cross-sectional view of a second seal assembly of the gearbox of FIG. 2.

FIG. 5 is a flow chart of steps for laser cladding a substrate part to form laser cladded mechanical face seals in accordance with an aspect of the disclosure.

FIG. 6 is a partial cross-sectional view of an exemplary substrate part being formed in accordance with an aspect of the disclosure.

FIG. 7 is a partial cross-sectional view of the exemplary substrate part of FIG. 6 after exposing a laser to a planar surface of the substrate part and supplying a coating material to the planar surface in accordance with an aspect of the disclosure.

FIG. 8 is a partial cross-sectional view of the substrate part in FIG. 7 depicting a section of a coating surface that may be removed during a finishing process.

FIG. 9 is a partial cross-sectional view of the substrate part in FIG. 7 depicting an inner diameter side and an outer diameter side that may be removed during a finishing process.

### DETAILED DESCRIPTION

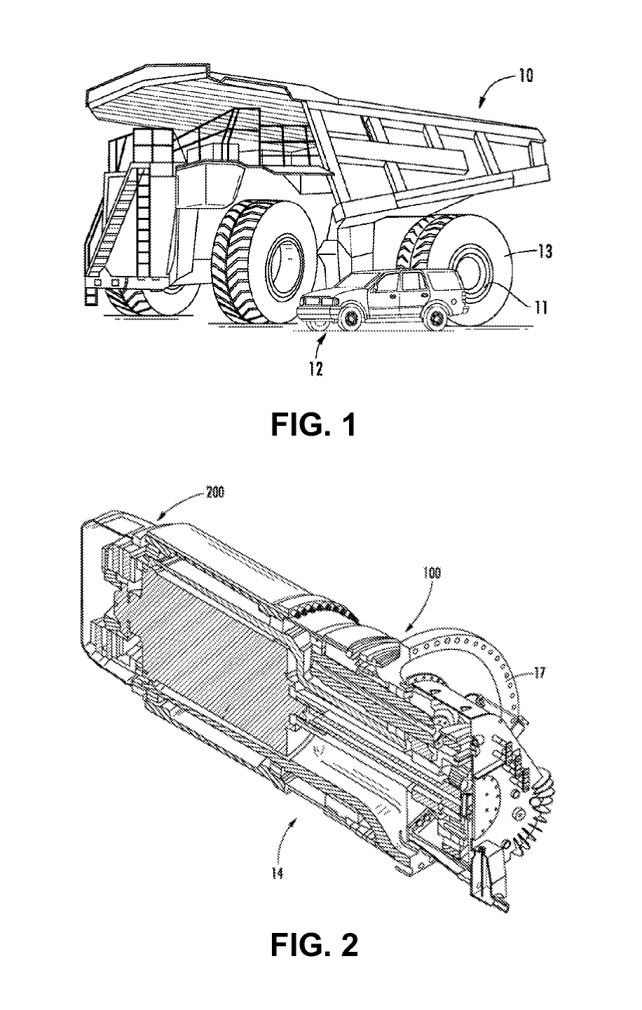

Now referring to the drawings, FIG. 1 shows an exemplary machine 10 in related art where mechanical face seals may be used to provide a fluid seal. The machine 10 may be in the form of a mining truck and is depicted next to a full-sized sports utility vehicle 12 to show a size and scale of the two machines. The machine 10 is typically employed to transport a payload of several hundred tons and operates in extreme environmental conditions. The environmental and payload demands exceed typical demands placed on machinery in other fields and therefore components must be designed and built to withstand the extreme conditions and demands.

The machine 10 may be driven by an internal combustion engine (not shown) or other suitable power plant. The engine or suitable power plant may be activated to provide motive force to rotatably drive a wheel hub 11 and associated tire 13 of the machine 10. As shown in FIG. 2, a wheel gear unit 14 in the related art may be interposed between the engine of the machine 10 and the wheel hub 11 to provide an appropriate amount of output torque and speed. The wheel gear unit 14 includes a flange 17 that may be used to mount the wheel hub 11.

It should be noted that the machine 10 shown in FIG. 1 and reference to seals is for the purpose of brevity. The disclosure may be utilized with any type of machine and any type of mechanical component in such a machine that may be subject to operation in extreme environmental conditions.

Referring to FIG. 2, the wheel gear unit 14 may include a first mechanical face seal assembly 100 and a second mechanical face seal assembly 200. The first mechanical face seal assembly 100 and the second mechanical face seal assembly 200 provide fluid seals to components of the wheel gear unit 14. Leaks or failure at the mechanical face seal assemblies 100, 200 may be detrimental to internal components of the wheel gear unit 14 and may result in accelerated wear and tear, equipment failure, and downtime required for cleaning, repairing, or maintaining the equipment.

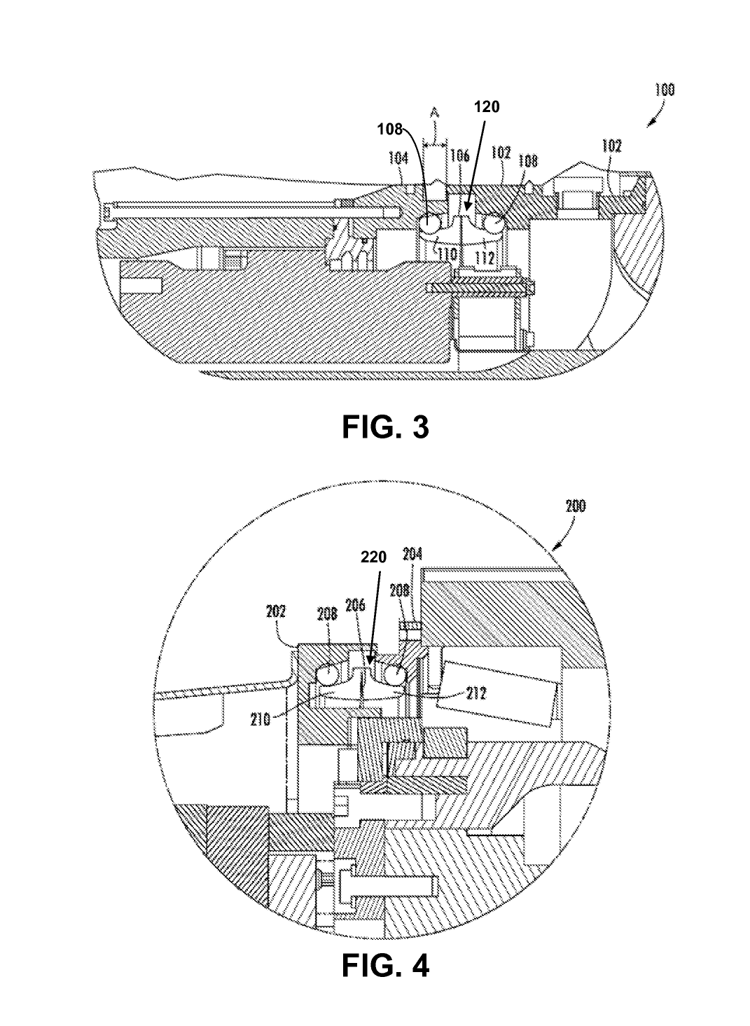

Turning to FIG. 3, the first mechanical face seal assembly 100 may include a fixed retainer 102, a rotating retainer 104, a rotating seal ring 110, and a static seal ring 112. An O-ring 108 may be provided between the fixed retainer 102 and the static seal ring 112, and between the rotating retainer 104 and rotating seal ring 110. The fixed retainer 102 and the rotating retainer 104 may each include angled surfaces to compress their respective O-rings 108. In response to the compression force, the O-rings 108 may press the rotating seal ring 110 and the static seal ring 112 against each other such that the rotating seal ring 110 applies a frictional torque on the static seal ring 112, thereby forming a fluid seal at interface 106. While a Duo-Cone™ mechanical face seal is shown in FIGS. 3 and 4, a laser cladding process of the present disclosure, as will be described in further detail below, may be performed on any suitable mechanical face seal, including but not limited to heavy duty dual face (HDDF) seals.

Turning to FIG. 4, the second mechanical face seal assembly 200 may include a fixed retainer 202, a rotating retainer 204, a static seal ring 210, and a rotating seal ring 212. An O-ring 208 may be provided between the fixed retainer 202 and the static seal ring 210, and between the rotating retainer 204 and rotating seal ring 212. The fixed retainer 202 and the rotating retainer 204 may each include an angled surface to compress their respective O-rings 208. In response to the compression force, the O-rings 208 may press the static seal ring 210 and the rotating seal ring 212 against each other such that the rotating seal ring 212 applies a frictional torque on the static seal ring 210, thereby forming a fluid seal at interface 206.

The rotating seal ring 110 and the static seal ring 112 together form a first mechanical face seal 120 and the static seal ring 210 and the rotating seal ring 212 together form a second mechanical face seal 220. As discussed above, a rotational torque is applied at the interface 106 of the first mechanical face seal 120 and at the interface 206 of the second mechanical face seal 220. The seal rings 110, 112, 210, 212 may each be made of cast iron. However, due to the constant rotational torque and frictional contact experienced at the interfaces 106, 206, and due to the extreme operating conditions when utilized in applications such as the machine 10, the seal rings 110, 112, 210, 212 require regular maintenance and replacement, leading to prolonged downtime of the machine 10.

While efforts have been made to make seal rings out of more exotic materials that are more capable of resisting wear, those materials are substantially more expensive, and are more difficult and time intensive to form into required geometries of the mechanical face seals. Additionally, attempts have been made in the related art to coat mechanical face seals using twin-wire arc (TWA) spray, diamond-like coatings (DLC), or high velocity oxygen fuel (HVOF). However, these methods have led to coatings that lacked durability, delaminated from the substrate, lead to unacceptable surface cracking or similar failure.

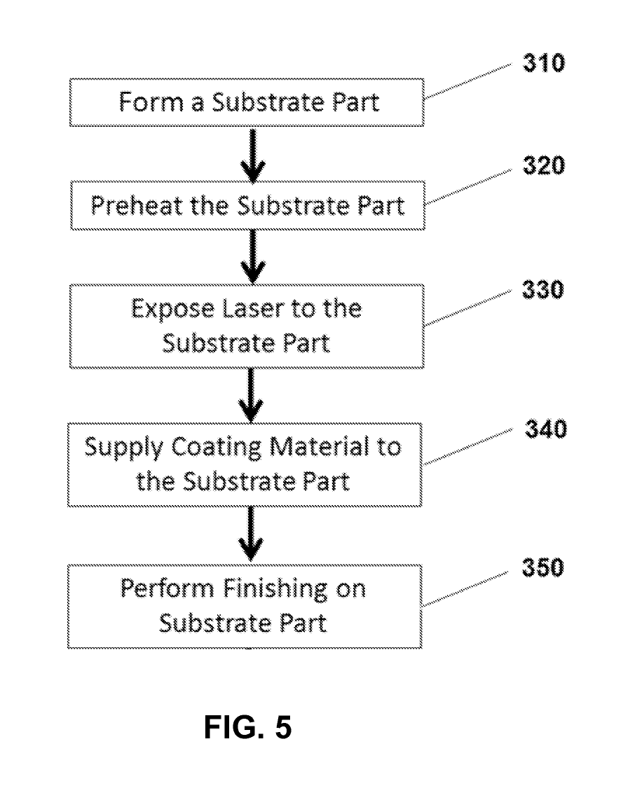

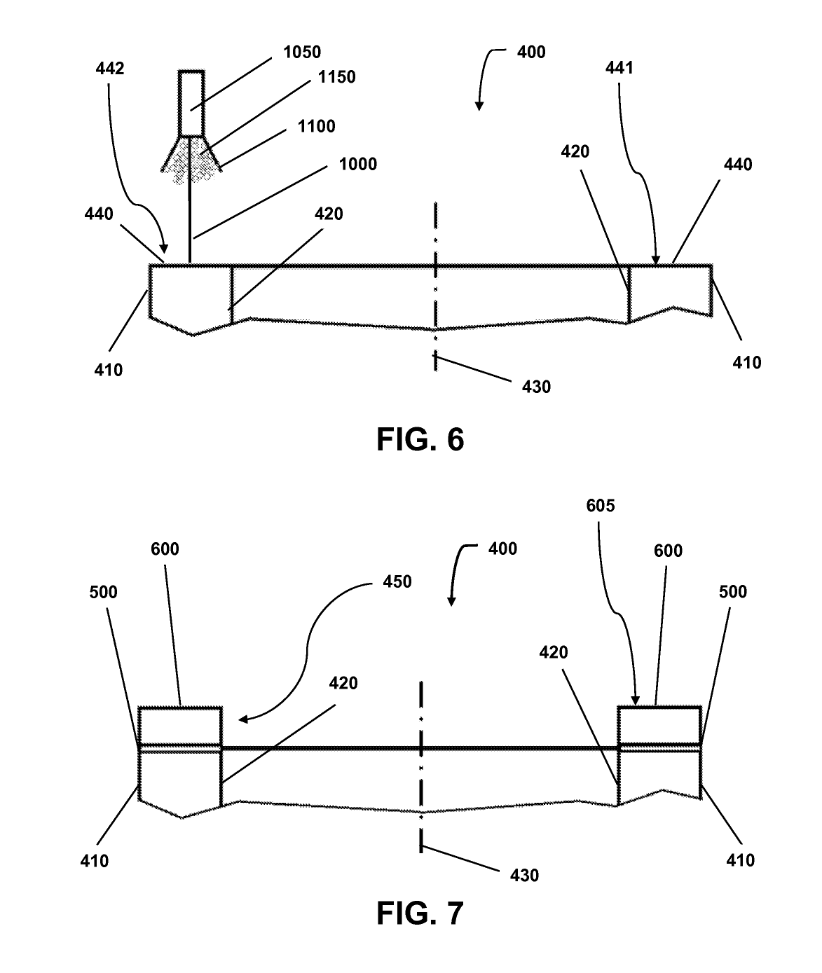

Referring to FIGS. 5 and 6, the disclosure provides a method of forming mechanical face seals using a laser cladding process that may enable use of less expensive substrates, increase performance, and reduce manufacturing complexity. The method may include an obtaining step 310 to obtain a substrate part 400. In the obtaining step 310, the substrate part 400 may be wrought or cast using an SAE 52100 alloy steel, SAE 1020 alloy steel, SAE 1040 alloy steel, ductile iron, or grey cast iron. Other materials are contemplated as well. The substrate part 400 may be wrought or cast to have roughly a geometry of a finished mechanical face seal. In addition, or as an alternative, the substrate part 400 may be formed by a powder metallurgy or other suitable process. In select aspects, the obtaining step 310 may comprise of refurbishing, repairing, or salvaging a previously used or damaged substrate part in order to obtain a substrate part 400.

After the substrate part 400 has been obtained, the substrate part 400 may undergo a preheating step 320. The preheating step 320 may include heating the substrate part 400 in an oven, applying resistive heating to the substrate part 400, applying a suitable coil to promote induction heating of the substrate part 400 and/or a like heating process. In select aspects, the suitable coil may be a U-shaped coil or a pancake coil. In select aspects, a laser 1000 may be exposed to a top layer 441 of the substrate part 400 to heat at least a planar surface 440 of the substrate part 400.

An exposing step 330 may be performed whereby the laser 1000 is exposed to the surface of the substrate part 400, either for the first time, or a subsequent time if a preheating step 320 is performed by the laser 1000. During the exposing step 330, the laser 1000 may trace along the top layer 441 of the substrate part 400, at least partially melting the top layer 441 of material of the substrate part 400.

A supplying step 340 may be performed just before, during, or just after the exposing step 330 begins. During the supplying step 340, a coating material 1150 is supplied to the top layer 441 of the substrate part 400 at or near a location of the laser 1000 being traced on the planar surface 440, whereby the top layer 441 of the substrate part 400 is melted together with the coating material 1150 via the laser 1000 to form an intermediate layer 500. The intermediate layer 500 may include both the coating material 1150 and a material of the substrate part 400, as shown in FIG. 7. The supplying step 340 may further include supplying the coating material 1150 to be melted by the laser 1000 to form a cladding layer 600 disposed above the intermediate layer 500, as shown in FIG. 7. In one aspect, the exposing step 330 and/or the supplying step 340 may be performed to form the cladding layer 600 without or substantially without any cracks or any defects, such as oxides or pores.

A finishing step 350 may be performed on the substrate part 400. The finishing step 350 may also be performed on the intermediate layer 500 and/or the cladding layer 600 formed during the supplying step 340. The finishing step 350 may comprise of a surface finishing process which may include one or more of grinding, polishing, milling, machining, or other suitable process to finish one or more surfaces of the substrate part 400. The surface finishing process of the finishing step 350 may be performed to refine one or more of a surface texture, thickness, inner diameter, outer diameter and/or similar feature of the substrate part 400 to obtain final dimensions that correspond to a finished metal face seal. The finishing step 350 may comprise of a heat treatment process, which may be performed before or after the surface finishing process, to enhance material properties of the substrate part 400. The heat treatment process may include thermal hot flattening where the substrate part 400 is compressed in a thermally controlled environment to relieve product stresses. In one aspect, the exposing step 330 and/or the supplying step 340 may be performed to form the cladding layer 600 without or substantially without any cracks, and such that cracks do not form in the cladding layer 600 during the finishing step 350.

Referring to FIG. 6, the substrate part 400 may include at least an outer diameter surface 410 and an inner diameter surface 420 extending along a common central axis 430. The substrate part 400 may include a planar surface 440 extending between the outer diameter surface 410 and the inner diameter surface 420. When processed and finished, the planar surface 440 of the substrate part 400 may form a surface of a mechanical seal ring for contact at an interface of mechanical face seals. As discussed above with respect to the obtaining step 310, the substrate part 400 may be wrought or cast using an SAE 52100 alloy steel, SAE 1020 alloy steel, SAE 1040 alloy steel, ductile iron, or grey cast iron. In select aspects, the obtaining step 310 may comprise of refurbishing, repairing, or salvaging a previously used or damaged substrate part in order to obtain a substrate part 400.

During the obtaining step 310, the substrate part 400 may be formed into a ring-shaped element. In select aspects, the substrate part 400 may be made of SAE 52100 alloy steel, which may have a chemical composition of 1.3% to 1.6% chromium, 0.93% to 1.1% carbon, 0.25% to 0.45% manganese, 0.15% to 0.35% silicon, up to 0.025% sulfur, up to 0.025% phosphorous, and a balance of iron. In select aspects, the substrate part 400 may be made of SAE 1020 alloy steel, which may have a chemical composition of 0.18% to 0.23% carbon, 0.3% to 0.6% manganese, up to 0.04% phosphorus, up to 0.05% sulfur, and a balance of iron. In select aspects, the substrate part 400 may be made of SAE 1040 alloy steel, which may have a chemical composition of 0.37% to 0.44% carbon, 0.6% to 0.9% manganese, up to 0.04% phosphorus, up to 0.05% sulfur, and a balance of iron. In select aspects, the substrate part 400 may be made of ductile iron, which may have a chemical composition of 3.0% to 3.9% carbon, 1.7% to 2.9% silicon, 0.1% to 0.6% manganese, 0.02% to 0.06% magnesium, 0.005% to 0.04% phosphorus, up to 0.04% sulfur, up to 0.4% copper, and a balance of iron. In select aspects, the cast iron substrate may be made of grey cast iron, which may have a chemical composition of 2.5% to 4.0% carbon, 1% to 3% silicon, and a balance of iron.

During a laser cladding process, the substrate part 400 may be preheated, as discussed in the preheating step 320 described above. The substrate part 400 may be heated in an oven, resistively heated, inductively heated via a pancake coil or other suitable induction coil, or heated by exposing the top layer 441 of the substrate part 400 to the laser 1000. In select aspects, the laser 1000 may trace over the planar surface 440 to heat up at least the top layer 441 of the planar surface 440.

After the substrate part 400 has been obtained, the exposing step 330 may be performed, which may occur with or without performance of the preheating step 320. During the exposing step 330, the laser 1000 may trace along the planar surface 440 of the substrate part 400 causing the top layer 441 of the planar surface 440 to at least partially melt. In select aspects, the exposing step 330 may include adjusting or controlling a power level of the laser 1000.

Concurrently with or just after the exposing step 330, as the laser 1000 traces over at least one portion 442 of the top layer 441, the supplying step 340 may be performed to supply the coating material 1150 to the portion 442 of the planar surface 440 at or near a location of the laser 1000 traced on the planar surface 440. The supplied coating material 1150 may be fed through a supplier 1100, which is positioned to deliver the coating material 1150 at or near the portion 442 of the planar surface 440 being traced by the laser 1000. In select aspects, the supplier 1100 may be attached to a laser generator 1050 that generates the laser 1000. In select aspects, the supplier 1100 may be integral with the laser generator 1050, as shown in FIG. 6. In select aspects, the supplying step 340 may include controlling a feed rate of the coating material 1150 via the supplier 1100.

The coating material 1150 may be in the form of a wire or a powder, and the coating material 1150 may be made of Fe-based alloys, Ni-based alloys, and/or Co-based alloys. In select aspects, the coating material 1150 may include Durmat® 60A, M2 tool steel, Stellite® 1, Stellite® 6, or other suitable material. In select aspects where the coating material 1150 is supplied in the form of a wire, the wire may be heated prior to being supplied to the planar surface 440. In select aspects, the coating material 1150 may consist of a Ni-based alloy having a chemical composition of 16-17% chromium, 3.3% boron, 3.8% silicon, 0.8% to 1.0% carbon, and a balance of nickel. In select aspects, the coating material 1150 may consist of a Fe-based alloy having a chemical composition of 0.78% to 1.05% carbon, 0.15% to 0.40% manganese, 0.20% to 0.45% silicon, 2.0% to 4.5% chromium, 4.5% to 5.5% molybdenum, 5.5% to 6.75% tungsten, 1.75% to 2.20% vanadium, up to 0.3% nickel, up to 0.25% copper, up to 0.03% phosphorus, up to 0.03% sulfur, and a balance of iron. In select aspects, the coating material 1150 may consist of a Co-based alloy having a composition of 26.5% to 33% chromium, 0.8% to 2.7% carbon, 3.5% to 20% tungsten, 0.8% to 1.2% silicon, up to 3% iron, up to 1.5% molybdenum, up to 1% manganese, and a balance of cobalt.

The supplier 1100 may be configured to feed a spool of the wire of the coating material 1150 or to spray a stream of powder of the coating material 1150 to the portion 442 of the planar surface 440. As the coating material 1150 is supplied to the portion 442 of the planar surface 440, during the supplying step 340, heat from the laser 1000 and/or the melted top layer 441 of the planar surface 440 may cause the coating material 1150 to melt and mix with the top layer 441 of the planar surface 440, thereby forming an intermediate layer 500, as shown in FIG. 7. The intermediate layer 500 may include a mix of both the coating material 1150 and the material of the substrate part 400.

The supplying step 340 may further supply coating material 1150 to be melted by the laser 1000 and/or heat from the intermediate layer 500 to form a cladding layer 600 disposed above the intermediate layer 500, as shown in FIG. 7. In select aspects, the cladding layer 600 may include primarily the coating material 1150 or may include exclusively the coating material 1150. In select aspects, a thickness of the intermediate layer 500 and the cladding layer 600 together may form a coating surface 450 on the substrate part 400 that is at least 0.1 μm thick.

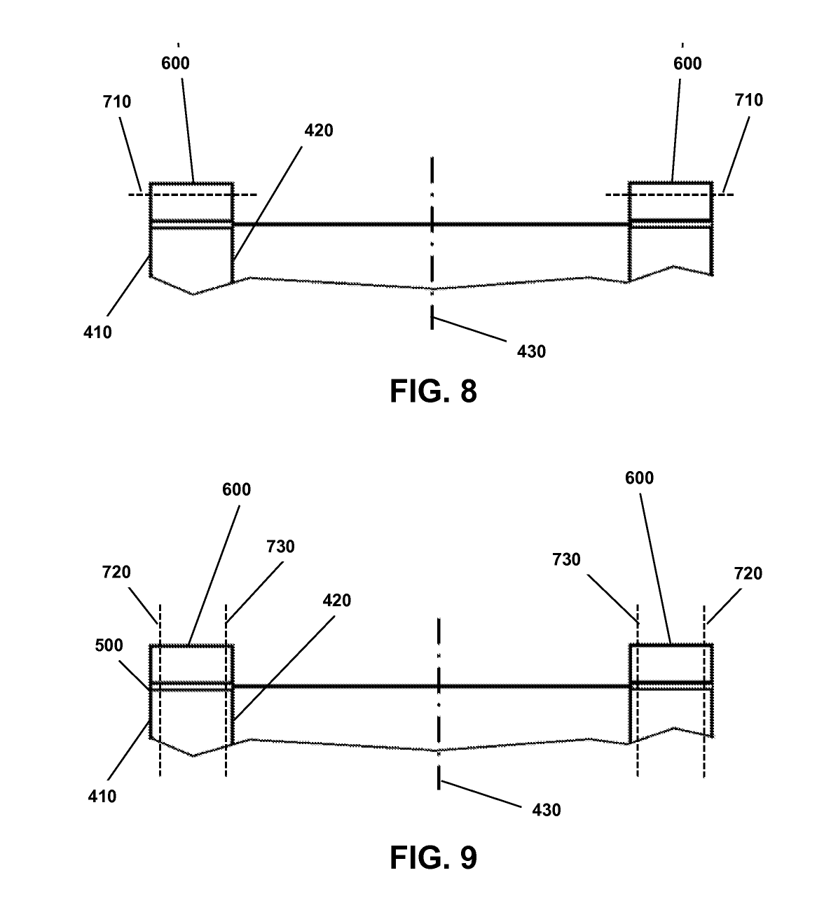

Turning to FIGS. 8 and 9, once the intermediate layer 500 and the cladding layer 600 have been formed on the substrate part 400, the finishing step 350 may be performed to obtain final dimensions that correspond to a finished metal face seal. As shown in FIG. 8, the finishing step 350 may comprise a surface finishing process which may include one or more of performing a grinding, polishing, milling, machining, or other suitable process to remove material 710 from a top surface 605 of the cladding layer 600 to obtain final dimensions of a finished metal face seal. In select aspects, the finishing step 350 may comprise of a heat treatment process, which may be performed before or after the surface finishing process, to enhance material properties of the substrate part 400. The heat treatment process may include thermal hot flattening where the substrate part 400 is compressed in a thermally controlled environment to relieve product stresses. In select aspects, the cladding layer 600 is finished to a cladding layer thickness of between 0.7 mm and 1.0 mm. The cladding layer 600 may have a Rockwell hardness of between HRC 60 and 65. In select aspects, the Rockwell hardness of the cladding layer 600 may be between 62 and 64. In select aspects, the top surface 605 of the cladding layer 600 is free of cracks.

As shown in FIG. 9, in select aspects, the finishing step 350 may include grinding, polishing, milling, machining, and/or other suitable machining process to remove material 720 from the outer diameter surface 410 of the substrate part 400, the intermediate layer 500, and/or the cladding layer 600 to obtain final dimensions that correspond to a finished mechanical face seal. In select aspects, the finishing step 350 may include grinding, polishing, milling, machining, and/or other suitable process to remove material 730 from the inner diameter surface 420 of the substrate part 400, the intermediate layer 500, and/or the cladding layer 600 to obtain final dimensions that correspond to a finished mechanical face seal.

### INDUSTRIAL APPLICABILITY

The disclosure is applicable to bearing surfaces, and in particular mechanical face seals. Various aspects of the disclosure provide a cost-effective substrate part that may be laser cladded to achieve superior strength and resistance against harsh environments. As shown in FIGS. 6-9, the substrate part 400 may be laser cladded and finished to form a mechanical face seal which may be used in heavy duty rotating applications, such as axles, gearboxes, tracked vehicles, conveyer systems, etc. As shown in FIGS. 3 and 4, the mechanical face seals, when installed in a rotating application, may include two identical metal seal rings 110, 112, 210, 212 that are mounted face-to-face with one another in two separate housings or retainers. One of the two metal seal rings 112, 210 remains static in its respective retainer 102, 202, while the other of the two metal seal rings 110, 212 rotates with its counter face rotating retainer 104, 204.

In one aspect of the disclosure, the substrate part 400 may be provided in the obtaining step 310. As shown in FIG. 6, the substrate part 400 may be wrought or cast out of SAE 52100 steel, SAE 1020 alloy steel, SAE 1040 alloy steel, ductile iron, or grey cast iron. In select aspects, the substrate part 400 may be made of SAE 52100 alloy steel, the SAE 52100 alloy steel having a chemical composition of 1.3% to 1.6% chromium, 0.93% to 1.1% carbon, 0.25% to 0.45% manganese, 0.15% to 0.35% silicon, up to 0.025% sulfur, up to 0.025% phosphorous, and a balance of iron. In select aspects, the substrate part 400 may be made of SAE 1020 alloy steel, which may have a chemical composition of 0.18% to 0.23% carbon, 0.3% to 0.6% manganese, up to 0.04% phosphorus, up to 0.05% sulfur, and a balance of iron. In select aspects, the substrate part 400 may be made of SAE 1040 alloy steel, which may have a chemical composition of 0.37% to 0.44% carbon, 0.6% to 0.9% manganese, up to 0.04% phosphorus, up to 0.05% sulfur, and a balance of iron. In select aspects, the substrate part 400 may be made of ductile iron, which may have a chemical composition of 3.0% to 3.9% carbon, 1.7% to 2.9% silicon, 0.1% to 0.6% manganese, 0.02% to 0.06% magnesium, 0.005% to 0.04% phosphorus, up to 0.04% sulfur, up to 0.4% copper, and a balance of iron. In select aspects, the cast iron substrate may be made of grey cast iron, the grey cast iron having a chemical composition of 2.5% to 4.0% carbon, 1% to 3% silicon, and a balance of iron.

In one aspect of the disclosure, the coating material 1150 supplied to the top layer 441 of the substrate part 400 may be made of Fe-based alloys, Ni-based alloys, or Co-based alloys. In select aspects, the coating material 1150 may include Durmat® 60A, M2 tool steel, Stellite® 1, Stellite® 6, or other suitable material. In select aspects, the coating material 1150 may consist of a Ni-based alloy having a chemical composition of 16-17% chromium, 3.3% boron, 3.8% silicon, 0.8% to 1.0% carbon, and a balance of nickel. In select aspects, the coating material 1150 may consist of a Fe-based alloy having a chemical composition of 0.78% to 1.05% carbon, 0.15% to 0.40% manganese, 0.20% to 0.45% silicon, 2.0% to 4.5% chromium, 4.5% to 5.5% molybdenum, 5.5% to 6.75% tungsten, 1.75% to 2.20% vanadium, up to 0.3% nickel, up to 0.25% copper, up to 0.03% phosphorus, up to 0.03% sulfur, and a balance of iron. In select aspects, the coating material 1150 may consist of a Co-based alloy having a composition of 26.5% to 33% chromium, 0.8% to 2.7% carbon, 3.5% to 20% tungsten, 0.8% to 1.2% silicon, up to 3% iron, up to 1.5% molybdenum, up to 1% manganese, and a balance of cobalt.

In one aspect of the disclosure, the substrate part 400 may be preheated in the preheating step 320. The substrate part 400 may be exposed to the laser 1000 during the exposing step 330, and coating material 1150 may be supplied to the top layer 441 of the substrate part 400 to form the intermediate layer 500 and/or the cladding layer 600. The finishing step 350 may be performed to finish the top surface 605 of the cladding layer 600, the outer diameter surface 410 of the substrate part 400, and/or the inner diameter surface 420 of the substrate part 400 during a surface finishing process. The finishing step 350 may include a heat treatment process where the substrate part 400 is compressed in a thermally controlled environment to relieve product stresses. In select aspects, the top surface 605 of the cladding layer 600 is free of cracks. Once finished, the substrate part 400 forms a completed mechanical face seal, which may be used in rotating applications such as axles, gearboxes, tracked vehicles, conveyer systems, etc. The low cost substrate part 400 in addition to the cladding layer 600 enables mechanical faces seals to be produced in a more cost effective manner while still providing the necessary strength and durability to withstand harsh environmental operating conditions.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method of producing a tightly dimensionally controlled mechanical face seal, the method comprising:
forming a cast or wrought substrate part, the substrate part having an inner diameter, an outer diameter, and a planar surface extending between the inner diameter and the outer diameter;
supplying a coating material to a top layer of the planar surface, the coating material comprising at least one of a Fe-based alloy, a Ni-based alloy, and a Co-based alloy; and
exposing a laser to at least the planar surface, the exposing including tracing the top layer of the planar surface to melt a top surface of the substrate part and the coating material together to form a metallurgical bond.

2. The method of claim 1, wherein the supplying includes feeding a powder stream or a wire of the coating material to the top layer of the planar surface.

3. The method of claim 2, wherein the supplying includes controlling a feed rate of the powder stream or the wire to form an intermediate layer at a location of a top surface of the planar surface prior to the exposing, the intermediate layer having a combination of the coating material and a material of the substrate part melted together, and
wherein a cladding layer is formed above the intermediate layer.

4. The method of claim 3, wherein the intermediate layer and the cladding layer form a coating surface on the substrate part that is free of cracks.

5. The method of claim 1, wherein the supplying includes feeding a powder stream or a wire of the coating material to the top layer of the planar surface while being exposed to the laser, the coating material and a material of the substrate part being melted together to form an intermediate layer, and
wherein the feeding includes supplying additional coating material to form a cladding layer.

6. The method of claim 5, wherein the cladding layer comprises the coating material.

7. The method of claim 5, wherein the cladding layer is formed above the intermediate layer.

8. The method of claim 5, wherein the intermediate layer and the cladding layer form a coating surface on the substrate part that is free of cracks.

9. The method of claim 5, further comprising finishing surfaces of the substrate part to form the mechanical face seal, the finishing including removing material from the cladding layer to yield a cladding layer thickness of between 0.7 mm and 1.0 mm.

10. The method of claim 9, wherein the finishing further includes removing the coating material and the material of the substrate part from at least one of the an inner diameter side and an outer diameter side.

11. The method of claim 1, wherein the substrate part is made of SAE 52100 alloy steel, SAE 1020 alloy steel, SAE 1040 alloy steel, ductile iron, or grey cast iron.

12. The method of claim 1, wherein the Fe-based alloy consists of 0.78% to 1.05% carbon, 0.15% to 0.40% manganese, 0.20% to 0.45% silicon, 2.0% to 4.5% chromium, 4.5% to 5.5% molybdenum, 5.5% to 6.75% tungsten, 1.75% to 2.20% vanadium, up to 0.3% nickel, up to 0.25% copper, up to 0.03% phosphorus, up to 0.03% sulfur, and a balance of iron,
wherein the Ni-based alloy consists of 16-17% chromium, 3.3% boron, 3.8% silicon, 0.8% to 1.0% carbon, and a balance of nickel, and
wherein the Co-based alloy consists of 26.5% to 33% chromium, 0.8% to 2.7% carbon, 3.5% to 20% tungsten, 0.8% to 1.2% silicon, up to 3% iron, up to 1.5% molybdenum, up to 1% manganese, and a balance of cobalt.

13. A mechanical face seal formed by the method of claim 1.

14. A method of producing a tightly dimensionally controlled mechanical face seal, the method comprising:
forming a cast or wrought substrate part, the substrate part having an inner diameter, an outer diameter, and a planar surface extending between the inner diameter and the outer diameter;
exposing a laser to at least one portion of the planar surface to preheat the substrate part; and
supplying a coating material to the planar surface that has been preheated and further exposing the laser to the at least one portion of the planar surface that has been preheated to melt a top surface of the substrate part and the coating material together to form a metallurgical bond,
wherein the coating material comprises at least one of a Fe-based alloy, a Ni-based alloy, and a Co-based alloy.

15. The method of claim 14, wherein the supplying includes feeding a powder stream or a wire of the coating material to the at least one portion of the planar surface while being exposed to the laser, the coating material and a material of the substrate part being melted together to form an intermediate layer, and
wherein the feeding includes supplying additional coating material to form a cladding layer above the intermediate layer.

16. The method of claim 15, wherein the intermediate layer and the cladding layer form a coating surface on the substrate part that is free of cracks.

17. The method of claim 15, further comprising finishing surfaces of the substrate part to form the mechanical face seal, the finishing including removing material from the coating surface to yield a cladding layer thickness between 0.7 mm to 1.0 mm thick.

18. The method of claim 14, wherein the substrate part comprises made of SAE 52100 alloy steel, SAE 1020 alloy steel, SAE 1040 alloy steel, ductile iron, or grey cast iron.

19. The method of claim 14, wherein the Fe-based alloy consists of 0.78% to 1.05% carbon, 0.15% to 0.40% manganese, 0.20% to 0.45% silicon, 2.0% to 4.5% chromium, 4.5% to 5.5% molybdenum, 5.5% to 6.75% tungsten, 1.75% to 2.20% vanadium, up to 0.3% nickel, up to 0.25% copper, up to 0.03% phosphorus, up to 0.03% sulfur, and a balance of iron,
wherein the Ni-based alloy consists of 16-17% chromium, 3.3% boron, 3.8% silicon, 0.8% to 1.0% carbon, and a balance of nickel, and
wherein the Co-based alloy consists of 26.5% to 33% chromium, 0.8% to 2.7% carbon, 3.5% to 20% tungsten, 0.8% to 1.2% silicon, up to 3% iron, up to 1.5% molybdenum, up to 1% manganese, and a balance of cobalt.

20. A method of producing a tightly dimensionally controlled mechanical face seal, the method comprising:
forming a cast or wrought substrate part made of SAE 52100 alloy steel, SAE 1020 alloy steel, SAE 1040 alloy steel, ductile iron, or grey cast iron, the substrate part having an inner diameter, an outer diameter, and a planar surface extending between the inner diameter and the outer diameter;
exposing a laser to at least one portion of the planar surface to preheat the substrate part; and
supplying a coating material comprising a Fe-based alloy, a Ni-based alloy, or a Co-based alloy to the planar surface that has been preheated and further exposing the laser to the at least one portion of the planar surface that has been preheated to melt a top surface of the substrate part and the coating material together to form a metallurgical bond,
wherein the supplying and further exposing forms an intermediate layer by melting the coating material and a material of the substrate part together, and forms a cladding layer of the coating material above the intermediate layer,
wherein the Fe-based alloy consists of 0.78% to 1.05% carbon, 0.15% to 0.40% manganese, 0.20% to 0.45% silicon, 2.0% to 4.5% chromium, 4.5% to 5.5% molybdenum, 5.5% to 6.75% tungsten, 1.75% to 2.20% vanadium, up to 0.3% nickel, up to 0.25% copper, up to 0.03% phosphorus, up to 0.03% sulfur, and a balance of iron,
wherein the Ni-based alloy consists of 16-17% chromium, 3.3% boron, 3.8% silicon, 0.8% to 1.0% carbon, and a balance of nickel, and
wherein the Co-based alloy consists of 26.5% to 33% chromium, 0.8% to 2.7% carbon, 3.5% to 20% tungsten, 0.8% to 1.2% silicon, up to 3% iron, up to 1.5% molybdenum, up to 1% manganese, and a balance of cobalt.
